(19) United States
(12) Patent Application Publication
(10) Pub. No.: US 2010/0205226 A1
(43) Pub. Date: Aug. 12, 2010

(54) UNIQUE REFERENCING SCHEME IDENTIFIER FOR LOCATION

(76) Inventors: Anne Bezancon, Oakland, CA (US); Daniel Parkes, San Francisco, CA (US)

Correspondence Address: DLA PIPER LLP (US ), 2000 UNIVERSITY AVENUE, EAST PALO ALTO, CA, 94303-2248, US

(21) Appl. No.: 12/413,424

(22) Filed: Mar. 27, 2009

Related U.S. Application Data
(60) Provisional application No. 61/152,188, filed on Feb. 12, 2009.

(51) Int. Cl. G06F 17/30

(52) U.S. Cl. 707/803; 707/E17.018; 707/E17.108

(57) ABSTRACT

System and method for processing electronic information that identifies a location relevant to electronic information, and associates a location ID code with the electronic information that defines the identified location using a computing device. The location ID code includes a first component that includes version information, a second component that includes country information of the identified location, a third component that includes longitude and latitude coordinates for the identified location, and a fourth component that includes a semantic address expression of the identified location.

### RELATED APPLICATIONS

This application claims the benefit of U.S. Provisional Application No. 61/152,188, filed Feb. 12, 2009.

### FIELD OF THE INVENTION

The present invention relates to location identification, and more particularly to a referencing scheme identifier for location.

### BACKGROUND OF THE INVENTION

There are many well known location ID schemes used to identify locations around the world. The two main methods are semantic and spatially referential. The most common semantic method is an address scheme that uses streets as physical landmarks, and numbers to differentiate between different locations that abut the same street. Addressing schemes also typically include city, state, province and/or country names, along with zip codes or other postal codes, to differentiate between streets in different regions having the same name. However, address based ID schemes only approximately identify that portion of the street abutting the location. Further, they do not identify the metes and bounds (i.e. the area) associated with each address. Address schemes do not identify those locations which have not yet been developed (i.e. where streets have not yet been built). Lastly, address schemes vary between countries, so that the format of the address schemes used in some countries differ from those used in other countries.

The most common spatial referencing method to identify location utilizes geo-coding, which are codes that correspond to longitude/latitude coordinates which define a point or discrete area. Geo-coding, and more particularly the use of longitude/latitude coordinates, can more precisely define a point or area than just mere address. However, a geo-code by itself is not useful to most users, organizations and database systems, most of which do not employ longitude/latitude coordinates. For example, most users, organizations, and database systems do not refer to a home address with “42.564,-101.923”. Therefore, geo-coding schemes are not as prevalent as address schemes (most users, organizations and database systems use address schemes to refer to location). Moreover, there are several geo-code standards, as geo-coding formats tend to vary among geo-coding users. Lastly, it can be imprecise and cumbersome to translate between geo-codes and addresses (which requires extensive look-up tables that are hard to keep up to date given the dynamic nature of address information, especially when attempting to reference location in many countries).

Yet another location identifier scheme utilizes Link IDs, which identify the physical locations of street segments, and the addresses associated with the ends of the segments. In order to locate an address in-between the street segments ends, the address would have to be interpolated to find an approximate position where the address would be located along the given street segment. Link IDs can be imprecise, especially for street segments in which the physical locations of the address numbers are not evenly distributed along the street segment. Moreover, Link IDs identify a strip of the street segment against which the location abuts, but fail to identify or define the area of the location associated with that strip of the street segment.

There is a need for an ID scheme that can define location in a way that is precise, absolutely deterministic, extensible, mutually exclusive, cumulatively exhaustive and international.

### BRIEF SUMMARY OF THE INVENTION

The need for the unique location defining ID scheme is met by providing a method of processing electronic information that includes identifying a location relevant to electronic information, and associating a location ID code with the electronic information that defines the identified location using a computing device. The location ID code includes a first component that includes version information, a second component that includes country information of the identified location, a third component that includes longitude and latitude coordinates for the identified location, and a fourth component that includes a semantic address expression of the identified location.

The need for the unique location defining ID scheme is also met by providing a system for processing electronic information that includes a computing device that is configured to identify a location relevant to electronic information, and associate a location ID code with the electronic information that defines the identified location. The location ID code includes a first component that includes version information, a second component that includes country information of the identified location, a third component that includes longitude and latitude coordinates for the identified location, and a fourth component that includes a semantic address expression of the identified location.

The need for the unique location defining ID scheme is also met by providing a system for processing electronic information that includes a plurality of computing devices. One of the plurality of computing devices is configured to identify a plurality of locations within a geographic area, generate a plurality of unique location ID codes each corresponding to one of the identified locations, and send at least some of the generated plurality of unique location ID codes to others of the plurality of computing devices. Each of the location ID codes includes a first component that includes version information, a second component that includes country information of the corresponding identified location, a third component that includes longitude and latitude coordinates for the corresponding identified location, and a fourth component that includes a semantic address expression of the corresponding identified location.

Other objects and features of the present invention will become apparent by a review of the specification, claims and appended figures.

### BRIEF DESCRIPTION OF THE DRAWINGS

FIG. 1 is a diagram illustrating the components of the location ID code.

FIG. 2 is a diagram illustrating discrete locations, and regional locations encompassing at least some of the discrete locations.

FIG. 3 is a diagram illustrating databases connected together via a network for sharing electronic information and/or location ID codes.

FIG. 4 is a flow diagram illustrating a process that utilizes location ID codes of the present invention.

FIG. 5 is a diagram illustrating a database for performing the process of FIG. 4.

FIG. 6 is a diagram illustrating an alternate network embodiment for utilizing the location ID codes of the present invention.

### DETAILED DESCRIPTION OF THE INVENTION

The present invention is a unique reference identity scheme for location (Location ID Code), in which a fixed bit length code (e.g. 64 bits) uniquely and fully identifies any location around the world. The location ID code includes four encoded components:

1. Version

2. Country

3. Geo-Code

4. Semantic Address

The Version component provides for the accommodation of different version restrictions on the format of each encoded component of the location ID code. In this way, multiple versions of the location ID code can be used at the same time, each with differing format restrictions.

The Country component provides for the accommodation of different language, format and local idiosyncrasies in the semantic address expressions used around the world. Since the semantic address expression for location can and does vary from country to country, knowing which country language, format and idiosyncrasy to use in interpreting the semantic address component give fuller meaning and accuracy to that component of the location ID code.

The Geo-Code component provides location identification using longitude/latitude coordinates. The coordinates can identify a point or an area encompassing, defining or otherwise related to the location, including the boundary lines of regularly or irregularly shaped areas that encompass or define the location. The geo-code could also identify a 3-dimensional surface or even a 3-dimensional volume related to the location (e.g. the 3-dimensional volume of a building at the location). Lastly, the geo-code component could identify a single square of a predetermined grid (used to divide the geographic area of interest) that is related to the location by inclusion, partial overlap, or close proximity between the single square and the location.

The Semantic Address component provides commonly used address expressions of location, which can vary in precision. Semantic address could be the actual street address (more precise, which includes street name and address number), as well as lesser precise expressions that could include neighborhood, county, city, state and/or other descriptors of location. The address expression could also include expressions of proximity to known locations or landmarks (e.g. a certain distance and direction from a given landmark).

By utilizing a location ID code with these four embedded components, there is no practical limit to the number of codes that can be used to describe location (i.e. the number of codes can be scaled over time). The number of codes can be expanded as new locations are identified, developed or defined. The code for any individual location would be mutually exclusive and deterministic with respect to any other individual location (i.e. no two different specific locations would have the same exact location ID code). It should be noted that a specific location could be associated with multiple location ID codes (e.g. a first location ID code that identifies just that location, and a second location ID code that identifies a region in which the location is found—however, those two location ID codes would still differ from each other). Because a single location ID code scheme can be used to identify any location around the word, it becomes much easier to map over (translate) existing location data that has previously been generated using other location identification schemes.

Another advantage of the location ID code with these four embedded components is that a unique location ID code for each possible location can be generated, even though some of the components themselves may not be unique to that location. For example, two different locations can be associated with the same Geo-Code component, or be associated with the same Semantic Address component. However, so long as their combination is unique for each of the two locations, then each of the location ID codes for these two locations is still unique. So, if two locations are associated with the same Geo-Code component, then different Semantic address expressions can be used to differentiate the two location ID codes for these locations. Likewise, if two locations are associated with the same Semantic Address expression, then different Geo-Code components can be used to differentiate the two location ID codes for these location. Thus, as is evident from the above, it is more important that the location ID code for each location be unique rather than having each component of the location ID code accurately and/or uniquely identify the location.

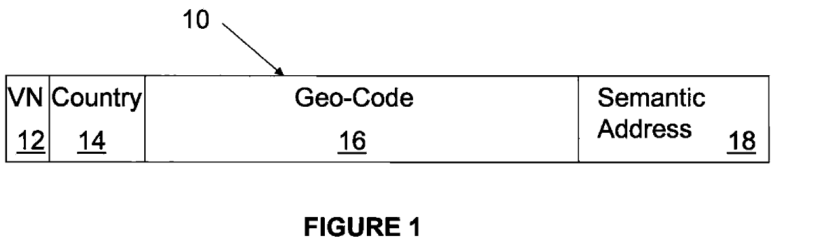

In a preferred non-limiting embodiment illustrated in FIG. 1, the location ID code 10 would be a sixty four bit code, with three bits for the version component 12, eight bits for the country component 14, thirty seven bits for the geo-code component 16, and sixteen bits for the semantic expression of address 18. The advantage of including the version component is that the format and length of each component and/or the ID code in general can change over time, yet multiple versions of the location ID code 10 can be utilized simultaneously with any system capable of interpreting the various versions.

Sample software code for generating the location ID codes 10 is as follows:

```
public void setGeoLocationID(GeoLocation geoLocation) {
    if (geoLocation == null) {
      return;
    }
    if (geoLocation.getGeocode( ) == null) {
      return;
    }
    long a = 0; // address hash (16 bits)
    long c = 0; // country index (8 bits)
    Address address = geoLocation.getAddress( );
    if (address != null) {
      if (address instanceof StreetAddress) {
        long b = 0;
        long s = 0;
        StreetAddress streetAddress =
(StreetAddress)address;
        Building building = streetAddress.getBuilding( );
        if (building != null && building.getNumber( ) !=
null) {
          b = building.getNumber( ).hashCode( );
        }
        Street street = streetAddress.getStreet( );
        if (street != null && street.getName( ) != null) {
          s = street.getName( ).hashCode( );
        }
        a = ((b\hat{ }s)<<48)>>>48;
      } else if (address.getAddressType( ) != null &&
address.getAddressType( ).getCode( ) != null) {
        long t =
address.getAddressType( ).getCode( ).hashCode( );
        a = (t<<48)>>>48;
      }
      if (address.getCountryCode( ) != null) {
        CountryConfiguration countryConfiguration =
getCountryConfiguration(address.getCountryCode( ));
        if (countryConfiguration != null) {
          c = countryConfiguration.getIndex( );
        }
      }
    }
    Geocode geocode = geoLocation.getGeocode( );
    long y = (long)((geocode.getLatitude( ) + 90.0) * 1000); //
latitude (18 bits)
    long x = (long)((geocode.getLongitude( ) + 180.0) * 1000); //
longitude (19 bits)
    geoLocation.setId((c<<53)\hat{ }(a<<37)\hat{ }(x<<18)\hat{ }y);
  }
```

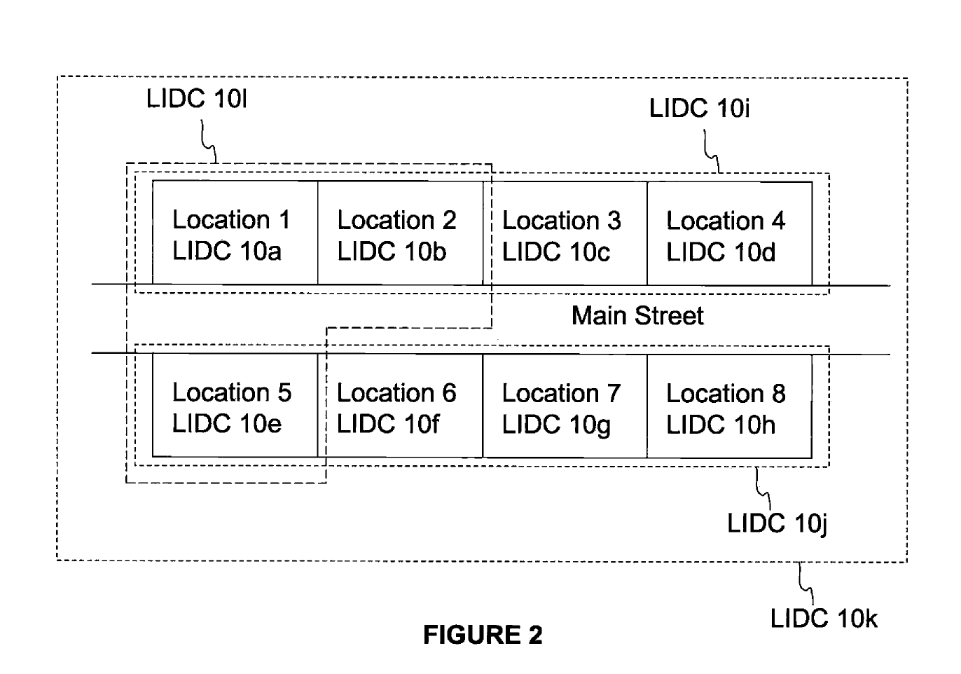

The location ID codes 10 can have varying degrees of granularity and overlap. For example, FIG. 2 illustrates 10 properties positioned along Main Street, where each property is a location. Locations 1-4 abut the north side of the street, and locations 5-8 abut the south side of the street. Each of the locations 1-8 is defined by the respective unique location ID codes 10a-10h. In addition, a location ID code 10i defines a regional location that contains all four locations 1-4 on the north side of Main Street, and a location ID code 10j defines a regional location that contains all four locations 5-8 on the south side of Main Street. Finally, location ID code 10k defines an even larger regional location (e.g. a neighborhood) that contains locations 1-8. Other location ID codes could define either larger regional locations such as a city, a county, a state, or even a country. Regional locations need not be symmetrical or uniform. For example, location ID code 101 defines a regional location that selectively contains locations 1, 2 and 5. The location ID codes 10 can be used to divide every portion of a given geographic area into discrete locations, as well as overlapping regional locations encompassing a plurality of the discrete locations. In this manner, electronic information having a relevancy to one or more locations (discrete and/or regional) can be associated with any and all appropriate location ID codes 10 for those relevant locations.

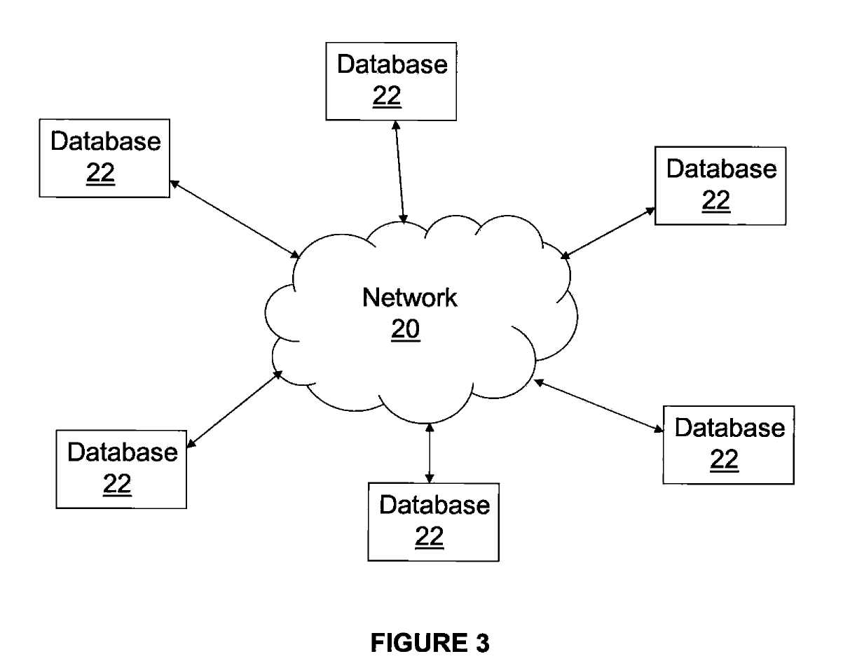

Electronic information (for example, an event announcement, a review, an article, business or residential information, an advertisement, a photograph, a video, etc.), or a link to such electronic content stored or accessible elsewhere, which is relevant to a particular location can be associated with a location ID code 10 that identifies with specificity that particular location (whether it be a single discrete location, multiple discrete locations, a regional location, a combination of both). In this manner, the electronic information can be exchanged between various information databases, where any of the databases can interpret the location ID code 10 associated with that electronic content. FIG. 3 illustrates a plurality of information databases 22 that exchange electronic information via a network 20. Databases 22 could, but need not necessarily, store the electronic information and/or links to other locations at which the electronic content is stored. The network 20 can be one or more point to point connections, a single network (e.g. the Internet), nested networks and/or multiple interconnected or separate networks. Network 20 can be wired and/or wireless. The associated location ID code(s) 10 allow any of the databases 22 to know what point(s) and/or area(s) on the globe are relevant to any given electronic information.

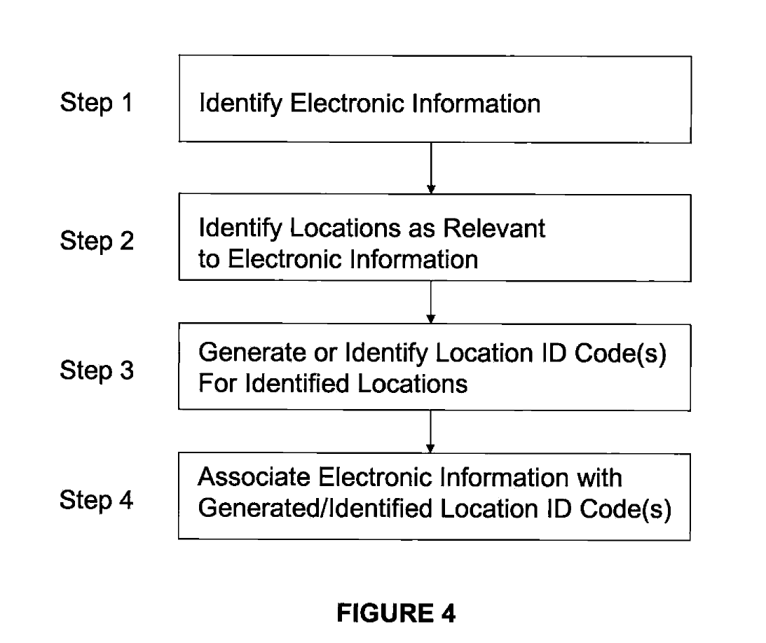

FIG. 4 illustrates a process of utilizing location ID codes 10. In step one, an electronic information is identified. In step two, one or more locations are identified as being relevant to the electronic information. This can be done by extracting or analyzing location information found in the electronic information, by translating embedded or attached alias codes that third parties use to identify location, or by otherwise determining all locations that should be associated with the electronic information. In step three, location ID codes 10 defining these locations are generated or identified. In step four, the electronic information is associated with the generated or identified location ID codes 10. Associating as used herein contemplates any technique that a database can use to link any data fields of the electronic information to one or more relevant location ID codes 10, and vice versa, or tagging the electronic information with the location ID code 10 by adding, attaching or inserting the code to the electronic information. For example, look up tables could be used to link location ID codes 10 to relevant electronic information by names or storage addresses. Or, the location ID code 10 can be inserted into a header or other field of the electronic information.

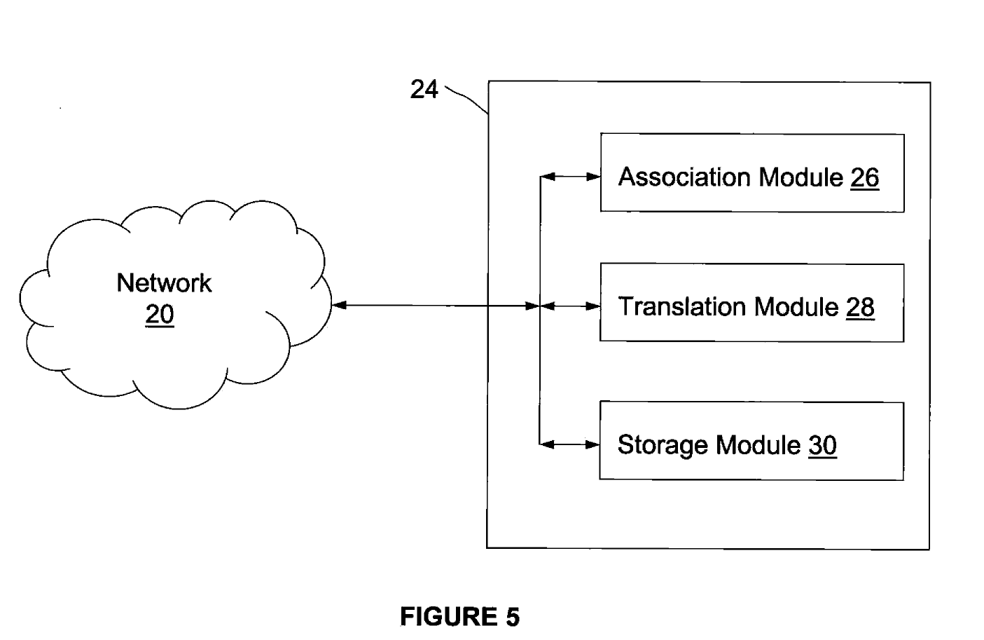

FIG. 5 illustrates a database 24 for performing the process of FIG. 4. The database 24 is connected to network 20 for receiving the electronic information, or receiving information about the electronic information. The database 24 includes an association module 26 which identifies location(s) that are relevant to the electronic information, and associates that electronic information with the appropriate location ID code(s) 10. The association module 26 either generates the location ID code(s) 10 dynamically, or retrieves them from an internal or external source. An optional translation module 28 translates any third party alias codes for the electronic data to identify the location(s) relevant to the electronic information. Storage module 30 can store some or all of the electronic information. Storage module 30 also can store the location ID code(s) 10 associated with the electronic information. The database 24 can further respond to queries seeking electronic information relevant to a particular location. The query can include the location ID code(s) 10. Or, association module 26 can determine which location ID code(s) 10 are relevant to the query. In response, the database 24 can identify (or even provide) electronic information that has been associated with the location ID code(s) 10 and/or locations that are relevant to the query.

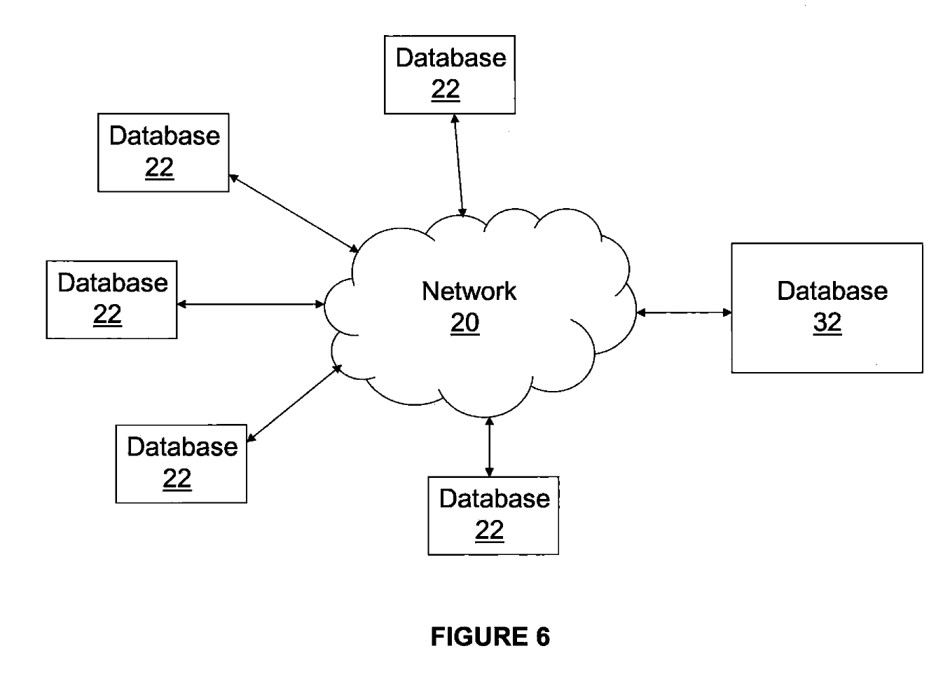

FIG. 6 illustrates another embodiment, in which a database 32 is configured to provide location ID codes 10 for all known or possible locations within one or more geographic regions to other databases 22 connected to the network 20. Specifically, database 32 identifies all known discrete locations within a geographic region, and/or all known regional locations within the geographic region, and generates location ID codes for all such locations. By then disseminating these generated location ID codes 10, or serving as a directory for all active location ID codes 10, the database 32 will provide a finite number of location ID codes for other databases 22 to choose from as they process location relevant electronic information. Database 32 can be tasked with keeping all location ID codes 10 used over network 20 current, especially as new locations are identified or are created, or existing locations are changed, within the geographic region(s) of interest. For example, if location 1 in FIG. 1 having a location ID code 10a is subdivided into two different locations, database 32 can be responsible for generating two location ID codes for the two different locations, and disseminating those codes over network 20 along with a notification that location ID code 10a is no longer operative. Alternately, the existing location ID code 10a can be modified to cover one of the two different locations, and a new location ID code can be generated for the other different location, where the database can disseminated the corrected code and the new code over the network 20.

It is to be understood that the present invention is not limited to the embodiment(s) described above and illustrated herein, but encompasses any and all variations falling within the scope of the appended claims. For example, references to the present invention herein are not intended to limit the scope of any claim or claim term, but instead merely make reference to one or more features that may be covered by one or more of the claims. Further, as is apparent from the claims and specification, not all method steps need be performed in the exact order illustrated or claimed, but rather in any order that allows the proper location identification and the location ID code generation and utilization. The responsibilities of database 32 can be shared among other databases on network 20. Databases 22, 24 and/or 32 can be any computing device having a processor or microprocessor that can receive electronic information from the network 20, and generate or identify appropriate location ID codes 10 for use over the network. Electronic information, including the location ID codes, can be shared among databases or other computing devices without necessarily utilizing network 20 (e.g. CDs, DVDs, memory keys and cards, etc.).

The present invention can be embodied in the form of methods and apparatus for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

What is claimed is:

1. A method of processing electronic information, comprising:
identifying a location relevant to electronic information; and
associating a location ID code with the electronic information that defines the identified location using a computing device, wherein the location ID code comprises:
a first component that includes version information,
a second component that includes country information of the identified location,
a third component that includes longitude and latitude coordinates for the identified location, and
a fourth component that includes a semantic address expression of the identified location.

2. The method of claim 1, wherein the associating comprises:
dynamically generating the location ID code in response to the identifying.

3. The method of claim 1, wherein the associating comprises:
identifying the location ID code from among a plurality of location ID codes.

4. The method of claim 1, wherein the associating comprises:
retrieving the location ID code from a second computing device.

5. The method of claim 1, further comprising:
identifying a plurality of locations within a geographic area;
generating a plurality of unique location ID codes each corresponding to one of the identified locations and each comprising:
a first component that includes version information,
a second component that includes country information of the corresponding identified location,
a third component that includes longitude and latitude coordinates for the corresponding identified location, and
a fourth component that includes a semantic address expression of the corresponding identified location; and
storing the generated plurality of unique location ID codes in a storage device.

6. The method of claim 5, wherein:
the location identified as relevant to the electronic information is one of the plurality of locations within the geographic area, and
the location ID code associated with the electronic information is one of the unique location ID codes.

7. The method of claim 5, wherein the plurality of locations comprises:
a plurality of discrete locations; and
a plurality of regional locations each including more than one of the discrete locations.

8. The method of claim 1, further comprising:
storing at least one portion of the electronic information along with the associated location ID code in a storage device.

9. The method of claim 8, wherein the at least one portion of the electronic information stored in the storage device includes a link to where corresponding electronic content is accessible.

10. The method of claim 1, further comprising:
receiving the electronic information by the computing device;
wherein the identifying comprises:
identifying location information within the received electronic information, and
identifying the location relevant to the electronic information based on the identified location information.

11. The method of claim 1, further comprising:
receiving the electronic information by the computing device;
wherein the identifying comprises:
identifying an alias code within the received electronic information, and
identifying the location relevant to the electronic information based on the identified alias code.

12. The method of claim 1, wherein the associating comprises:
attaching or inserting the location ID code to the electronic information.

13. The method of claim 1, wherein the associating comprises:
linking the location ID code with the electronic information.

14. A system for processing electronic information, comprising:
a computing device being configured to:
identify a location relevant to electronic information, and
associate a location ID code with the electronic information that defines the identified location, wherein the location ID code comprises:
a first component that includes version information,
a second component that includes country information of the identified location,
a third component that includes longitude and latitude coordinates for the identified location, and
a fourth component that includes a semantic address expression of the identified location.

15. The system of claim 14, wherein the computing device is configured to dynamically generate the location ID code in response to the identification of the location relevant to the electronic information.

16. The system of claim 14, wherein the computing device is configured to identify the location ID code from among a plurality of location ID codes.

17. The system of claim 14, wherein the computing device is configured to retrieve the location ID code from a second computing device.

18. The system of claim 14, wherein the computing device comprises a storage device configured to store at least one portion of the electronic information along with the associated location ID code.

19. The system of claim 18, wherein the at least one portion of the electronic information stored in the storage device includes a link to where corresponding electronic content is accessible.

20. The system of claim 14, wherein the computing device is further configured to:
receive the electronic information;
identify location information within the received electronic information, and
identify the location relevant to the electronic information based on the identified location information.

21. The system of claim 14, wherein the computing device is further configured to:
receive the electronic information;
identify an alias code within the received electronic information, and
identify the location relevant to the electronic information based on the identified alias code.

22. The system of claim 14, wherein the computing device is further configured to:
attach or insert the location ID code to the electronic information.

23. The system of claim 14, wherein the computing device is further configured to:
link the location ID code with the electronic information.

24. A system for processing electronic information, comprising:
a plurality of computing devices;
one of the plurality of computing devices being configured to:
identify a plurality of locations within a geographic area,
generate a plurality of unique location ID codes each corresponding to one of the identified locations and each comprising:
a first component that includes version information,
a second component that includes country information of the corresponding identified location,
a third component that includes longitude and latitude coordinates for the corresponding identified location, and
a fourth component that includes a semantic address expression of the corresponding identified location; and
send at least some of the generated plurality of unique location ID codes to others of the plurality of computing devices.

25. The system of claim 24, wherein the one computing device is configured to dynamically generate the unique location ID codes in response to the identification of the locations within the geographic area.

26. The system of claim 24, wherein the one computing device comprises a storage device configured to store the generated plurality of unique location ID codes.

27. The system of claim 24, wherein the plurality of locations comprises:
a plurality of discrete locations; and
a plurality of regional locations each including more than one of the discrete locations.

28. The system of claim 24, wherein the computing device is further configured to:
receive updated information regarding one of the plurality of locations;
modify the location ID code corresponding to the one location based on the received updated information; and
send the modified location ID code to others of the plurality of computing devices.

29. The system of claim 24, wherein the computing device is further configured to:
receive updated information regarding one of the plurality of locations;
generate a new location ID code corresponding to the one location based on the received updated information, wherein the new location ID code includes:
a first component that includes version information,
a second component that includes country information of the one location,
a third component that includes longitude and latitude coordinates for the one location, and
a fourth component that includes a semantic address expression of the one location; and
send the new location ID code to others of the plurality of computing devices.
